(19) United States
(12) Patent Application Publication
(10) Pub. No.: US 2020/0112047 A1
(43) Pub. Date: Apr. 9, 2020

(54) POWER STORAGE DEVICE

(71) Applicant: TOYOTA JIDOSHA KABUSHIKI KAISHA, Toyota-shi (JP)

(72) Inventor: Ryo KANADA, Toyota-shi (JP)

(73) Assignee: TOYOTA JIDOSHA KABUSHIKI KAISHA, Toyota-shi (JP)

(21) Appl. No.: 16/591,729

(22) Filed: Oct. 3, 2019

(30) Foreign Application Priority Data
Oct. 5, 2018 (JP) 2018-190077

(51) Int. Cl. H01M 10/04; H01M 10/0525; H01M 2/10; H01M 2/02; H01M 10/6554; H01M 4/02; H01M 10/0587

(52) U.S. Cl. CPC H01M 10/0431; H01M 10/0525; H01M 10/0413; H01M 10/0587; H01M 2/02; H01M 10/6554; H01M 4/02; H01M 2/1077

(57) ABSTRACT

A power storage device includes a power storage cell and a pressing member. The power storage cell includes an overlapping portion in which a separator, a positive electrode composite layer, and a negative electrode composite layer overlap with one another. The pressing member includes: a first pressing portion configured to press a portion that is included in an outer circumferential edge portion of the overlapping portion and that is adjacent to a first winding end face; and a second pressing portion configured to press a connection portion between a first flat portion and a first curved portion.

This nonprovisional application is based on Japanese Patent Application No. 2018-190077 filed on Oct. 5, 2018 with the Japan Patent Office, the entire contents of which are hereby incorporated by reference.

### BACKGROUND

### Field

The present disclosure relates to a power storage device.

### Description of the Background Art

Conventionally, power storage devices such as a lithium ion battery and a nickel-metal hydride battery have been proposed. Generally, a power storage device includes a plurality of power storage cells arranged in one direction and a restraining member for restraining the plurality of power storage cells. Each of the power storage cells includes an electrode body, a housing case in which the electrode body is housed, and an electrolyte solution housed in the housing case. The electrode body includes a positive electrode sheet, a separator, and a negative electrode sheet.

The restraining member includes two restraining plates and a fastening band. The restraining plates are disposed at their respective end portions of the power storage device in the direction in which the power storage cells are arranged. The fastening band is connected to each of the restraining plates so as to apply restraining force to the power storage cells between the restraining plates.

The electrode body is formed, for example, in such a manner that the positive electrode sheet, the separator and the negative electrode sheet stacked on one another are wound around a winding-axis line and further deformed in a flat shape. The wound-type electrode body formed in this way includes a pair of flat surfaces, a pair of end faces, and a pair of curved surfaces. The pair of flat surfaces are arranged in the thickness direction. The pair of curved surfaces are arranged in the height direction. Each of the curved surfaces connects the flat surfaces. Each of the end faces is located at a corresponding one of both ends in the direction in which the winding-axis line extends. Each of the end faces is formed by winding the outer peripheral edge of the positive electrode sheet, the outer peripheral edge of the separator, and the outer peripheral edge of the negative electrode sheet.

When the electrode body as described above is subjected to charging and discharging at a high rate in which charging and discharging at about 10 C to 20 C are continuously repeated, the temperature in the central portion of the electrode body becomes higher than the temperature in the circumferential edge portion of the electrode body. When the temperature in the central portion of the electrode body becomes higher than the temperature in the circumferential edge portion of the electrode body, the central portion of the electrode body is deformed so as to bulge greater than the end portion side of the electrode body. When the central portion of the electrode body greatly bulges, the surface pressure between the central portion of the electrode body and the housing case rises, and the central portion of the housing case is also pressed by the electrode body and thereby deformed so as to bulge. Accordingly, the end portion side of the housing case is also deformed so as to bulge outward as the central portion bulges. The end portion side of the housing case is deformed to bulge, whereas the end portion side of the electrode body is less deformed. Thus, the surface pressure between the end portion side of the electrode body and the housing case decreases. As a result, the internal pressure in the electrode body is higher in the central portion than on the end portion side.

When the internal pressure in the electrode body is higher in the central portion than on the end face side, an electrolyte solution moves toward the end face, and then moves from the end face to the outside of the electrode body. When the electrolyte solution moves to the outside of the electrode body, lithium salt and the like in the electrolyte solution also moves to the outside of the electrode body as the electrolyte solution moves. Accordingly, the salt concentration in the electrode body is lower in the central portion than on the end face side. When the salt concentration becomes uneven in this way, the internal resistance in the lithium ion battery rises.

Thus, in a power storage device disclosed in Japanese Patent Laying-Open No. 2016-4724, a pressurizing plate is disposed between power storage cells that are arranged. The pressurizing plate is provided with a first load unit and a second load unit. The first load unit is located on the end face side of a flat surface of an electrode body with a housing case interposed therebetween. The second load unit is located in the central portion of the flat surface of the electrode body with the housing case interposed therebetween. Also, the first load unit is higher in thermal expansion coefficient than the second load unit.

When charging and discharging at a high rate is executed in this power storage device, the first load unit and the second load unit expand due to the heat of the electrode body. In this case, since the first load unit is higher in thermal expansion coefficient than the second load unit, the first load unit expands greater than the second load unit. Thereby, the pressing force applied by the first load unit for pressing the end portion of the electrode body with the housing case interposed therebetween is larger than the pressing force applied by the second load unit for pressing the central portion of the electrode body with the housing case interposed therebetween.

Thereby, the electrolyte solution can be suppressed from leaking from the end face of the electrode body to the outside of the electrode body, so that the salt concentration inside the electrode body is suppressed from becoming uneven.

The above-described example shows the configuration for suppressing the internal resistance in the power storage cell from rising upon execution of charging and discharging at a high rate.

The power storage cell disclosed in Japanese Patent Laying-Open No. 2012-113935 introduces a configuration for suppressing the internal resistance in the power storage cell from rising when charging is performed continuously for a prescribed time period or when discharging is performed continuously for a prescribed time period.

When charging of the power storage cell is continuously performed for a prescribed time period, the surface pressure in the electrode body is higher in the end portion than in the central portion. On the other hand, when discharging from the power storage cell is continuously performed for a prescribed time period, the surface pressure in the electrode body becomes smaller in the end portion than in the central portion. In this way, when the surface pressure in the electrode body becomes uneven, the resistance in the power storage cell rises.

Thus, in the power storage cell disclosed in Japanese Patent Laying-Open No. 2012-113935, a pressure sensitive adhesive tape is attached to the end portion side of the electrode body. This pressure sensitive adhesive tape suppresses expansion or contraction of the end portion of the electrode body due to charging and discharging.

Thereby, also when charging is continuously performed for a prescribed time period or when discharging is continuously performed for a prescribed time period, the surface pressure in the electrode body is suppressed from becoming uneven.

### SUMMARY

In the power storage device disclosed in Japanese Patent Laying-Open No. 2016-4724, the first load unit of the pressurizing plate presses the end portion of the electrode body with the housing case interposed therebetween. Thus, it is difficult to correctly apply load to the end portion of the electrode body. For example, when the width of the first load unit is too large, load may be applied also to the central portion of the electrode body.

Upon execution of charging and discharging at a high rate in this case, the temperature in the electrode body becomes uneven between the central portion and the portion located at a curved surface. As a result, a gap is more likely to occur between the sheets in the boundary portion between the curved surface and the flat surface in the electrode body.

In the power storage device disclosed in Japanese Patent Laying-Open No. 2016-4724, no load is applied to the boundary portion between the curved surface and the flat surface. Similarly, also in the power storage device disclosed in Japanese Patent Laying-Open No. 2012-113935, no load is applied to the boundary portion between the curved surface and the flat surface of the electrode body.

Thus, in each of Japanese Patent Laying-Open Nos. 2016-4724 and 2012-113935, execution of charging and discharging at a high rate may produce a gap between the sheets of the electrode body, which may cause a problem that the internal resistance in the power storage cell rises.

Japanese Patent Laying-Open Nos. 2016-4724 and 2012-113935 each fail to consider a stack-type electrode body formed by sequentially stacking a positive electrode sheet, a separator and a negative electrode sheet.

The present disclosure has been made in consideration of the above-described problems. The first object of the present disclosure is to provide a power storage device including a wound-type electrode body capable of suppressing the internal resistance from rising despite execution of charging and discharging at a high rate. The second object of the present disclosure is to provide a power storage device including a stack-type electrode body capable of suppressing the internal resistance from rising despite execution of charging and discharging at a high rate.

A power storage device according to the present disclosure includes: an electrode body including a positive electrode sheet, a separator, and a negative electrode sheet; a housing case in which the electrode body is housed; an electrolyte solution housed in the housing case; and a pressing member provided inside the housing case and configured to press the electrode body.

The electrode body having the positive electrode sheet, the separator and the negative electrode sheet stacked on one another is wound around a winding-axis line. The positive electrode sheet includes a positive electrode metal foil and a positive electrode composite layer that is formed on the positive electrode metal foil. The negative electrode sheet includes a negative electrode metal foil and a negative electrode composite layer that is formed on the negative electrode metal foil. The electrode body includes an overlapping portion formed of the positive electrode composite layer, the separator and the negative electrode composite layer.

The electrode body includes: a first flat portion and a second flat portion that are arranged in a thickness direction of the electrode body, each of the first flat portion and the second flat portion being formed in a flat plane shape; a first winding end face and a second winding end face that are arranged in an extending direction of the winding-axis line, each of the first winding end face and the second winding end face being formed by winding an end edge of the positive electrode sheet, an end edge of the separator and an end edge of the negative electrode sheet; a first curved portion located on a side of one end of the electrode body in a direction that intersects with the extending direction of the winding-axis line and that intersects with the thickness direction, the first curved portion being configured to connect the first flat portion and the second flat portion; and a second curved portion located on a side of the other end of the electrode body, the second curved portion being configured to connect the first flat portion and the second flat portion.

The pressing member includes: a first pressing portion configured to press a portion that is included in an outer circumferential edge portion of the overlapping portion and that is adjacent to the first winding end face; and a second pressing portion configured to press a connection portion between the first flat portion and the first curved portion.

According to the power storage device as described above, an electrolyte solution can be suppressed from leaking from the inside of the electrode body through the end face to the outside despite execution of charging and discharging at a high rate. Furthermore, a gap can be suppressed from occurring between sheets in the boundary portion between the curved portion and the flat portion upon execution of charging and discharging at a high rate.

The pressing member is formed of an insulating material, and disposed on an outer circumferential surface of the electrode body. The pressing member allows insulation between the electrode body and the housing case.

The electrode body has a hollow portion provided therein. The pressing member is formed of an insulating material and disposed in the hollow portion. The electrode body and the pressing member can be integrally formed, so that the electrode body and the pressing member can be readily housed in the housing case.

A power storage device according to the present disclosure includes: an electrode body formed by stacking a positive electrode sheet, a separator, and a negative electrode sheet in a stacking direction; a housing case in which the electrode body is housed; an electrolyte solution housed in the housing case; and a pressing member provided inside the housing case. The electrode body includes the positive electrode sheet, the separator, and the negative electrode sheet that are stacked in the stacking direction. The positive electrode sheet includes a positive electrode metal foil and a positive electrode composite layer that is formed on the positive electrode metal foil. The negative electrode sheet includes a negative electrode metal foil and a negative electrode composite layer that is formed on the negative electrode metal foil. The electrode body includes a stack portion formed by stacking the positive electrode composite layer, the separator, and the negative electrode composite layer. The electrode body includes a first main surface located at one end of the electrode body in the stacking direction and a second main surface located at the other end of the electrode body in the stacking direction. The pressing member is configured to press the electrode body along an outer circumferential edge portion of a region that is included in the first main surface and that is located at a position of the stack portion.

According to the power storage device as described above, pressing force is applied from the pressing member to the circumferential surface of the stack-type electrode body upon execution of charging and discharging at a high rate. Thereby, the electrolyte solution can be suppressed from leaking from the circumferential surface of the electrode body to the outside.

The pressing member is formed of an insulating material, and disposed on an outer circumferential surface of the electrode body. According to the power storage device as described above, the insulation between the electrode body and the housing case is ensured.

The pressing member is formed of an insulating material, and disposed inside the electrode body. Thus, the pressing member and the electrode body can be integrally inserted into the housing case, so that the pressing member and the electrode body can be readily housed in the housing case.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage device 1 according to the present first embodiment.

FIG. 2 is a perspective view showing a power storage cell 2.

FIG. 3 is an exploded perspective view showing power storage cell 2.

FIG. 4 is a perspective view showing an electrode body 11.

FIG. 5 is a perspective view showing electrode body 11.

FIG. 6 is a cross-sectional side view showing power storage cell 2.

FIG. 7 is a cross-sectional plan view schematically showing power storage cell 2.

FIG. 8 is a cross-sectional view showing the state where electrode body 11 is deformed to bulge.

FIG. 9 is an exploded perspective view showing a power storage cell 2A according to a comparative example.

FIG. 10 is a cross-sectional plan view showing power storage cell 2A in the event of charging and discharging at a high rate.

FIG. 11 is a cross-sectional side view showing power storage cell 2A in the event of charging and discharging at a high rate.

FIG. 12 is a cross-sectional side view showing a power storage cell 2B that is a modification of power storage cell 2.

FIG. 13 is a cross-sectional plan view showing power storage cell 2B.

FIG. 14 is an exploded perspective view showing a power storage cell 2C according to the present second embodiment.

FIG. 15 is a cross-sectional plan view showing power storage cell 2C.

FIG. 16 is a cross-sectional side view showing power storage cell 2C.

FIG. 17 is cross-sectional side view showing the state where electrode body 11C is thermally expanded due to execution of charging and discharging at a high rate.

FIG. 18 is a cross-sectional plan view showing the state where electrode body 11C is thermally expanded due to execution of charging and discharging at a high rate.

FIG. 19 is an exploded perspective view showing a power storage cell 2D.

FIG. 20 is a cross-sectional plan view showing power storage cell 2D.

FIG. 21 is a cross-sectional side view showing power storage cell 2D.

FIG. 22 is an exploded perspective view showing a power storage cell 2E according to the present fourth embodiment.

FIG. 23 is a perspective view showing a pressing member 162.

FIG. 24 is a cross-sectional view showing power storage cell 2E.

FIG. 25 is a cross-sectional side view showing power storage cell 2E.

### DESCRIPTION OF THE PREFERRED EMBODIMENTS

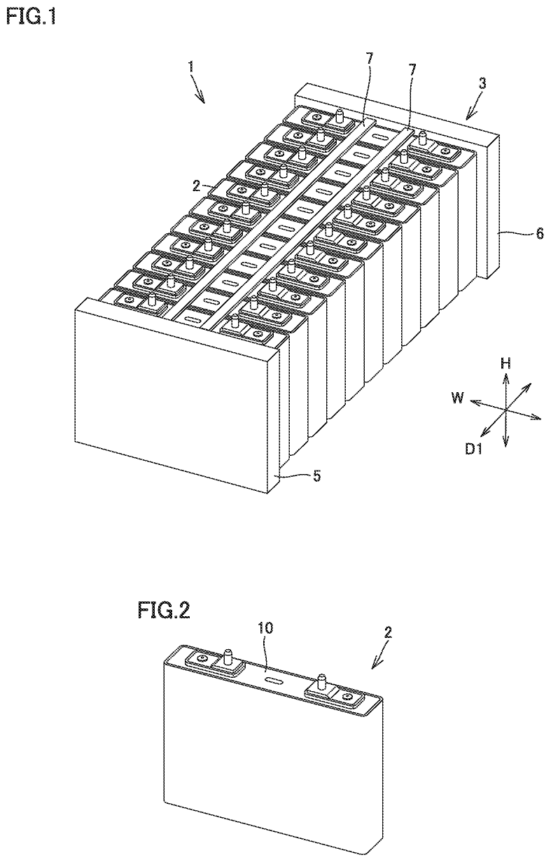

Referring to FIGS. 1 to 25, a power storage device according to the present embodiment will be described. Among the components shown in FIGS. 1 to 25, the same or substantially the same components will be designated by the same reference characters and the description thereof will not be repeated. Among the components described in the embodiment, the components corresponding to those recited in the claims may be described in the embodiments together with parenthesized names of the components recited in the claims.

### EMBODIMENTS

FIG. 1 is a perspective view showing a power storage device 1 according to the present first embodiment. Power storage device 1 includes a plurality of power storage cells 2 and a restraining member 3. The plurality of power storage cells 2 are provided so as to be arranged in an arrangement direction D1.

The plurality of power storage cells 2 are arranged in arrangement direction D1. An insulating plate (not shown) is disposed between power storage cells 2.

Restraining member 3 includes a restraining plate 5, a restraining plate 6, and a restraining band 7. Restraining plate 5 is disposed at one end of power storage device 1 in arrangement direction D1 while restraining plate 6 is disposed at the other end of power storage device 1 in arrangement direction D1. Restraining band 7 serves to connect restraining plates 5 and 6 and also restrain restraining plates 5 and 6.

The plurality of power storage cells 2 disposed between restraining plates 5 and 6 are pressed by restraining plates 5 and 6 and thereby restrained between restraining plates 5 and 6.

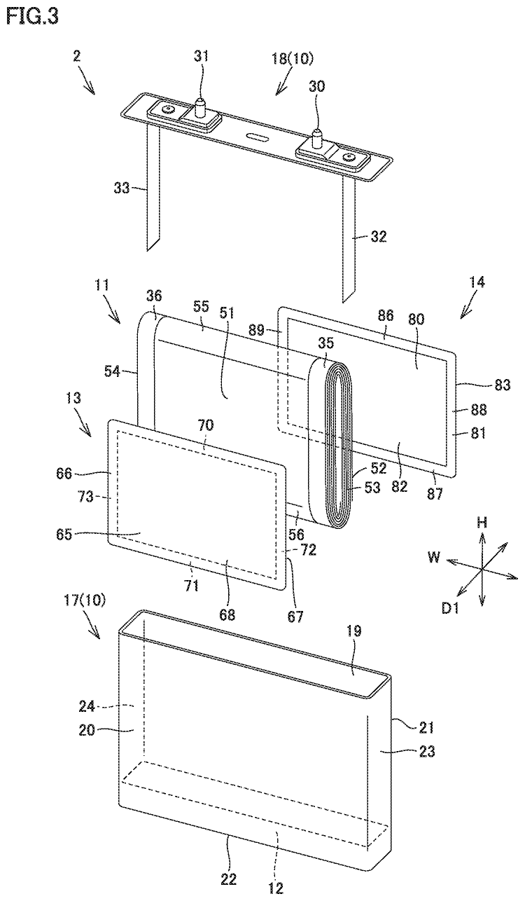

FIG. 2 is a perspective view showing power storage cell 2. Power storage cell 2 is formed in a rectangular parallelepiped shape having a flat plane shape. FIG. 3 is an exploded perspective view showing power storage cell 2.

Power storage cell 2 includes a housing case 10, an electrode body 11, an electrolyte solution 12, and pressing members 13 and 14.

Housing case 10 includes a case body 17 and a cover 18. Case body 17 is provided with an opening 19 that is opened upward.

Housing case 10 includes main plates 20 and 21, a bottom plate 22, and end face plates 23 and 24. Main plates 20, 21 and end face plates 23, 24 are formed so as to extend upward from the peripheral edge portion of bottom plate 22.

Main plates 20 and 21 are arranged in arrangement direction D1 while end face plates 23 and 24 are arranged in a width direction W. Opening 19 is provided to be opened upward.

Cover 18 is formed in a plate shape. Cover 18 has an upper surface on which a positive electrode external terminal 30 and a negative electrode external terminal 31 are disposed at a distance from each other in width direction W.

Cover 18 has a lower surface on which a positive electrode collector plate 32 and a negative electrode collector plate 33 are disposed. Positive electrode collector plate 32 is connected to positive electrode external terminal 30 while negative electrode collector plate 33 is connected to negative electrode external terminal 31.

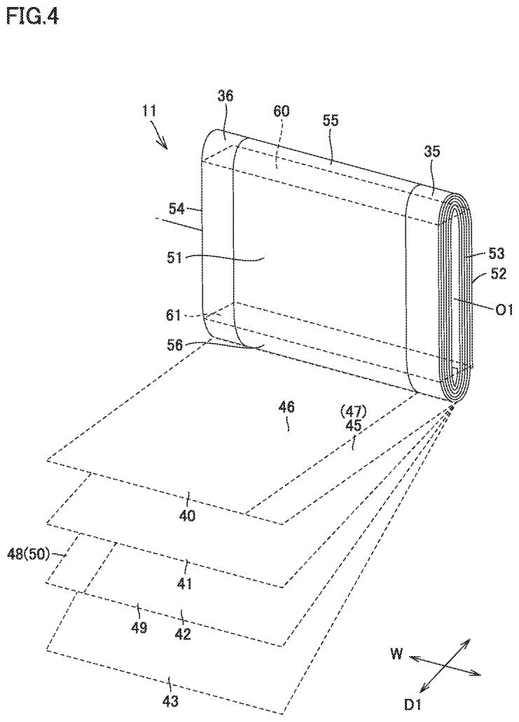

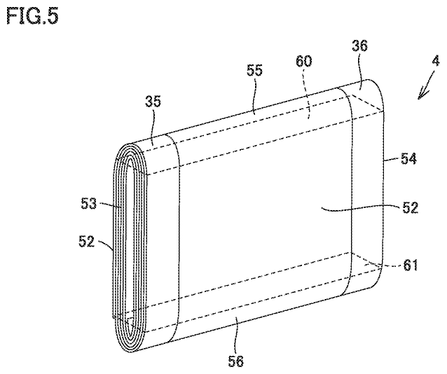

Electrode body 11 includes a positive electrode 35 and a negative electrode 36. FIGS. 4 and 5 each are a perspective view showing electrode body 11. Electrode body 11 includes a positive electrode sheet 40, a separator 41, a negative electrode sheet 42, and a separator 43. In FIG. 4, dashed lines show parts of positive electrode sheet 40, separator 41, negative electrode sheet 42, and separator 43 that have been removed from electrode body 11.

When electrode body 11 is formed, electrode body 11 is first formed of a stack layer sheet obtained by stacking positive electrode sheet 40, separator 41, negative electrode sheet 42, and separator 43. Then, this stack layer sheet is wound around a winding-axis line O1 to form a cylindrical winding component, which is then crushed by a metal mold, thereby forming electrode body 11 having a flat shape.

Positive electrode sheet 40 includes a metal foil 45 and a positive electrode composite layer 46. Metal foil 45 is formed of aluminum or the like, for example. Positive electrode composite layer 46 is formed on each of the front and back surfaces of metal foil 45. Metal foil 45 includes an unapplied portion 47 on which positive electrode composite layer 46 is not applied.

Positive electrode composite layer 46 contains a positive electrode active material, a conductive agent, a binding agent, and the like. Examples of the positive electrode active material may be NCM (Li(Ni, Co, Mn)O₂) and the like. Separators 41 and 43 each are formed of a porous nonwoven fabric and the like.

Negative electrode sheet 42 includes a metal foil 48 and a negative electrode composite layer 49. Metal foil 48 is formed of copper or the like, for example. Negative electrode composite layer 49 is formed on each of the front and back surfaces of metal foil 48. Metal foil 48 includes an unapplied portion 50 on which negative electrode composite layer 49 is not applied.

Negative electrode composite layer 49 contains a negative electrode active material, a binding agent, and a thickening agent. The negative electrode active material is formed, for example, by attaching and carbonizing a coat material (coat species), which may form an amorphous carbon film on the surface of a graphite particle (core material). The core material that can be used may be a material formed by processing (pulverizing, spherical molding and the like) various types of graphite such as natural graphite and artificial graphite into a particulate shape (spherical shape).

Then, metal foil 45 is wound around winding-axis line O1, thereby forming positive electrode 35. Also, metal foil 48 is wound around winding-axis line O1, thereby forming negative electrode 36.

Electrode body 11 configured as described above includes a flat portion (the first flat portion) 51, a flat portion (the second flat portion) 52, an end face (the first winding end face) 53, an end face (the second winding end face) 54, a curved portion (the first curved portion) 55, and a curved portion (the second curved portion) 56.

Flat portions 51 and 52 are arranged in arrangement direction D1 and each are formed in a flat plane shape by pressing a winding component by a metal mold.

End face 53 and end face 54 are arranged in width direction W. End faces 53 and 54 are arranged in the state where the edge portions of positive electrode sheet 40, separator 41, negative electrode sheet 42, and separator 43 are wound.

Curved portion 55 is formed so as to connect the upper edge of flat portion 51 and the upper edge of flat portion 52. Curved portion 55 is curved so as to bulge upward. Curved portion 56 is formed so as to connect the lower edge of flat portion 51 and the lower edge of flat portion 52. Curved portion 56 is curved so as to bulge downward. In FIG. 4, connection portion 60 serves as a portion connecting curved portion 55 and flat portion 51. Specifically, connection portion 60 is an inflection portion in which flat portion 51 having a flat plane shape shifts to curved portion 55 having a curved surface. Similarly, connection portion 61 is an inflection portion in which flat portion 51 having a flat plane shape shifts to curved portion 56 having a curved surface.

In FIG. 3, pressing member 13 is disposed on the flat portion 51 side of electrode body 11 while pressing member 14 is disposed on the flat portion 52 side of electrode body 11.

Pressing member 13 is formed of an insulating material such as a resin, for example. Pressing member 13 includes a plate portion 65 and a pressing portion 66. Plate portion 65 is formed in an approximately rectangular plate shape and also formed to be elongated in width direction W. Plate portion 65 includes a main surface 67 and a main surface 68 that are arranged in the thickness direction of plate portion 65.

Main surface 67 is located to face flat portion 51 of electrode body 11 while main surface 68 is located on the opposite side of main surface 67. Pressing portion 66 is provided on main surface 67 so as to be formed in a cyclic shape along the outer circumferential edge portion of main surface 67. Pressing portion 66 includes pressing edges (the second pressing portion) 70 and 71 and pressing edges (the first pressing portion) 72 and 73.

Pressing edge 70 is formed along the upper longer side of main surface 67 while pressing edge 71 is formed along the lower longer side of main surface 67. Pressing edge 72 is formed along one shorter side while pressing edge 73 is formed along the other shorter side.

Pressing member 14 is also formed of an insulating material. Pressing members 13 and 14 ensure the insulation between housing case 10 and electrode body 11. Pressing member 14 includes a plate portion 80 and a pressing portion 81. Plate portion 80 is formed in an approximately rectangular plate shape and includes a main surface 82 and a main surface 83.

Main surface 82 is located to face flat portion 52 of electrode body 11 while main surface 83 is located on the opposite side of main surface 82.

Pressing portion 81 is provided on main surface 82 of plate portion 80 so as to be formed in a cyclic shape along the outer circumferential edge portion of main surface 82. Pressing portion 81 includes pressing edges 86 and 87 extending along the longer side of main surface 82 and pressing edges 88 and 89 extending along the shorter side of main surface 82.

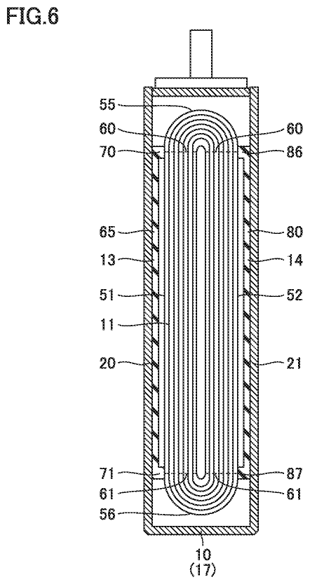

FIG. 6 is a cross-sectional side view showing power storage cell 2. Pressing member 13 is disposed between electrode body 11 and main plate 20 of case body 17. Pressing member 14 is disposed between electrode body 11 and main plate 21 of case body 17.

Pressing edge 70 of pressing member 13 presses connection portion 60 from the flat portion 51 side of electrode body 11. Pressing edge 71 of pressing member 13 presses connection portion 61 from the flat portion 52 side. On the other hand, the main surface of pressing member 13 is spaced apart from flat portion 51 of electrode body 11.

Pressing edge 86 of pressing member 14 presses connection portion 60 from the flat portion 52 side of electrode body 11. Pressing edge 87 presses connection portion 61 from the flat portion 52 side.

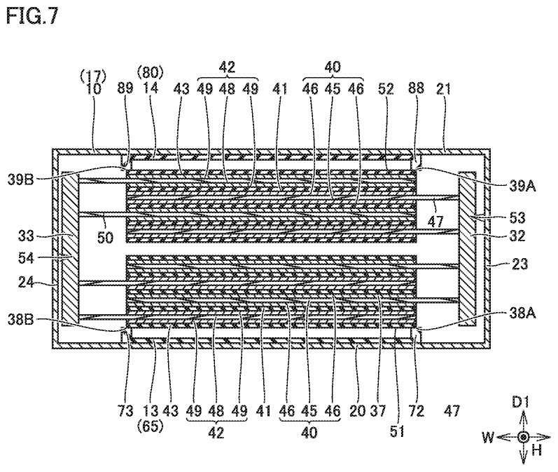

FIG. 7 is a cross-sectional plan view schematically showing power storage cell 2.

Negative electrode sheet 42 is sandwiched between separator 43 and separator 41. Unapplied portion 50 of negative electrode sheet 42 protrudes from separators 43 and 41 toward end face plate 24. Also, unapplied portion 50 is welded to negative electrode collector plate 33.

Separator 43 is formed so as to cover negative electrode composite layer 49 formed on one surface of negative electrode sheet 42. Separator 41 is formed so as to cover negative electrode composite layer 49 formed on the other surface of negative electrode sheet 42.

Similarly, separator 41 is formed so as to cover positive electrode composite layer 46 formed on one surface of positive electrode sheet 40. Separator 43 is formed so as to cover positive electrode composite layer 46 formed on the other surface of positive electrode sheet 40.

Thus, electrode body 11 includes an overlapping portion 37 in which positive electrode composite layer 46, separator 41, negative electrode composite layer 49, and separator 43 overlap with one another. Unapplied portion 47 of positive electrode sheet 40 protrudes from overlapping portion 37 toward end face plate 23. Also, positive electrode collector plate 32 is welded to unapplied portion 47.

The outer circumferential edge portion of overlapping portion 37 that is located on the outer surface of flat portion 51 includes an edge portion 38A and an edge portion 38B. Edge portion 38A is located on the end face 53 side while edge portion 38B is located on the end face 54 side.

Similarly, the outer circumferential edge portion of overlapping portion 37 that is located on the outer surface of flat portion 52 includes an edge portion 39A and an edge portion 39B. Edge portion 39A is located on the end face 53 side while edge portion 39B is located on the end face 54 side. In addition, edge portions 38A, 38B, 39A, and 39B are formed so as to extend in a height direction H.

Pressing edges 72 and 88 press edge portions 38A and 39A, respectively, from the outer surface side of electrode body 11. Similarly, pressing edges 73 and 89 press edge portions 38B and 39B, respectively, from the outer surface side of electrode body 11. Pressing edges 72, 73, 88, and 89 are formed so as to extend along edge portions 38A, 38B, 39A, and 39B, respectively.

Accordingly, on the end face 53 side, positive electrode sheet 40, separator 41, negative electrode sheet 42, and separator 43 are brought into close contact with one another by the pressing force from pressing edges 72 and 88. Similarly, on the end face 54 side, positive electrode sheet 40, separator 41, negative electrode sheet 42, and separator 43 are brought into close contact with one another by the pressing force from pressing edges 73 and 89.

Since the sheets are in close contact with one another in this way, electrolyte solution 12 inside electrode body 11 is suppressed from leaking from end faces 53 and 54 to the outside of electrode body 11. On the other hand, main surface 82 of plate portion 80 of pressing member 14 is spaced apart from flat portion 52 of power storage cell 2.

Then, upon execution of charging and discharging at a high rate, the temperature in the central portion of electrode body 11 rises. In particular, the temperature in the central portion of electrode body 11 in arrangement direction D1 and width direction W rises.

This is because heat is more likely to dissipate from the outer circumference side of electrode body 11 through pressing members 13, 14 and the like to housing case 10, whereas heat is more likely to be remained contained in the central portion of electrode body 11.

When the temperature in the central portion of electrode body 11 rises, the central portion of electrode body 11 is deformed to bulge by thermal expansion, so that the central portion of electrode body 11 comes into contact with pressing members 13 and 14.

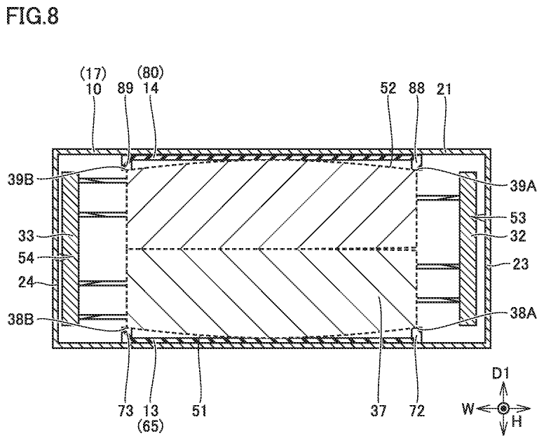

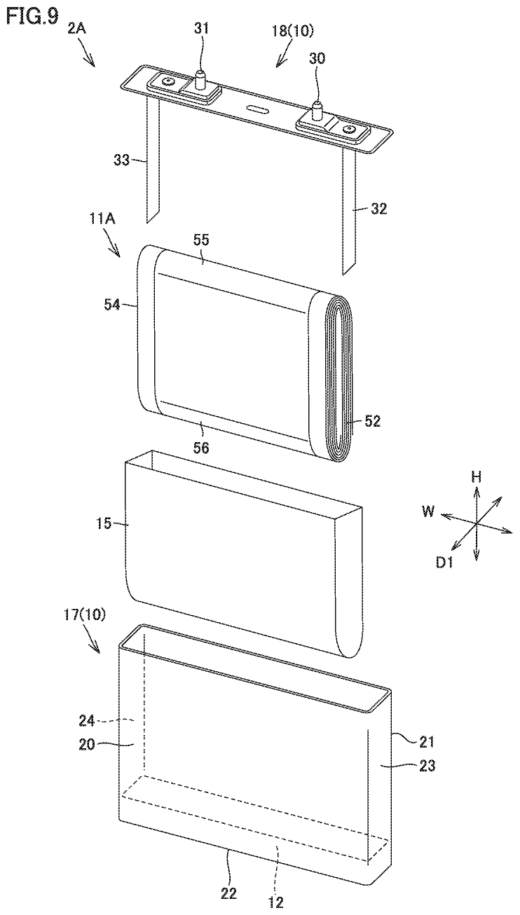

FIG. 8 is a cross-sectional view showing the state where electrode body 11 is deformed to bulge. When electrode body 11 is deformed to bulge, flat portion 51 of electrode body 11 is deformed to bulge outward, so that flat portion 51 comes into contact with plate portion 65 of pressing member 13. Similarly, flat portion 52 of electrode body 11 is deformed to bulge outward, so that flat portion 52 comes into contact with plate portion 80 of pressing member 14.

As the central portion of electrode body 11 is deformed to bulge in this way, the central portion of electrode body 11 is pressed by pressing members 13 and 14.

When the central portion of electrode body 11 is pressed by pressing members 13 and 14, the surface pressure between the sheets increases in the central portion of electrode body 11. Electrode body 11 is impregnated with electrolyte solution 12. When the surface pressure between the sheets increases in the central portion of electrode body 11, electrolyte solution 12 with which the central portion of electrode body 11 is impregnated tends to move toward end faces 53 and 54 of electrode body 11.

On the end face 54 side, edge portions 38B and 39B of electrode body 11 are pressed by pressing edges 73 and 89, respectively. Thus, the sheets such as the positive electrode sheet are in close contact with each other, so that electrolyte solution 12 is suppressed from leaking from the end face 54 side to the outside of electrode body 11.

Similarly, on the end face 53 side, edge portion 38A and edge portion 39A are pressed by pressing edge 72 and pressing edge 88, respectively, so that electrolyte solution 12 is suppressed from leaking from the end face 53 side to the outside of electrode body 11. In this way, electrolyte solution 12 can be suppressed from leaking from the inside of electrode body 11 to the outside of electrode body 11.

The following is an explanation about the advantage of power storage cell 2 according to the present first embodiment as compared with the power storage cell according to a comparative example.

FIG. 9 is a cross-sectional view showing a power storage cell 2A according to a comparative example. Power storage cell 2A does not include pressing members 13 and 14 of the present embodiment. On the other hand, insulating paper 15 is provided in order to suppress direct contact between the electrode body and the housing case.

This insulating paper 15 is formed so as to wrap an electrode body 11A from below, thereby suppressing contact between the circumferential surface of electrode body 11A and housing case 10. Insulating paper 15 is formed to have a uniform thickness in its entirety.

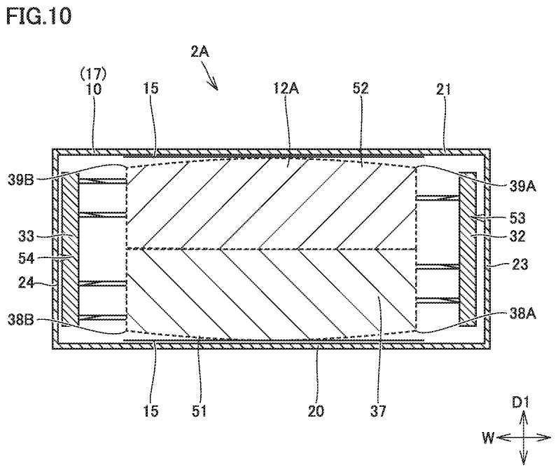

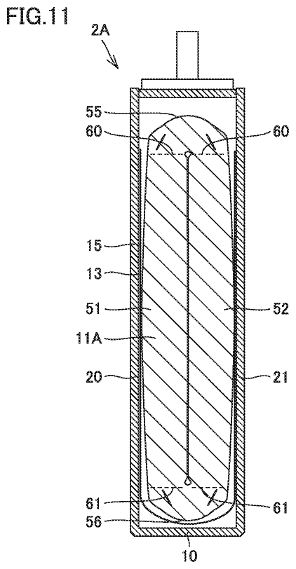

Upon execution of charging and discharging at a high rate in power storage cell 2A, the temperature in the central portion of electrode body 11A rises also in power storage cell 2A. FIG. 10 is a cross-sectional plan view showing power storage cell 2A in the event of charging and discharging at a high rate.

When the temperature in the central portion of electrode body 11A rises, flat portions 51 and 52 of electrode body 11A are deformed to bulge outward and then brought into contact with main plates 20 and 21, respectively, of housing case 10 with insulating paper 15 interposed therebetween.

The central portion of electrode body 11A in power storage cell 2A is pressed by main plates 20 and 21 while the central portions of main plates 20 and 21 are also pressed outward by electrode body 11A.

As the central portions of main plates 20 and 21 are deformed outward, portions of main plates 20 and 21 that are located on each of the end face plates 23 and 24 sides are also deformed outward.

As a result, the distance from each of main plates 20 and 21 to a portion of electrode body 11A that is located on each of the end faces 53 and 54 sides is increased.

Furthermore, power storage cell 2A does not include pressing members 13 and 14 of power storage cell 2 in the present embodiment. Thus, in electrode body 11A of power storage cell 2A, the pressing force is not applied to the region in the vicinity of each of end faces 53 and 54.

Thus, on the end faces 53 and 54 sides of electrode body 11A, the adhesiveness between the sheets is low, which allows electrolyte solution 12 to leak through the gap between the sheets to the outside of electrode body 11A.

Then, when the surface pressure between the sheets rises in the central portion of electrode body 11A, electrolyte solution 12 with which electrode body 11A is impregnated moves toward end faces 53 and 54, and then leaks through the gap between the sheets in each of end faces 53 and 54 to the outside of electrode body 11A.

Thus, the amount of electrolyte solution 12 in the central portion of electrode body 11A is reduced. On the other hand, there are gaps between the sheets on the end faces 53 and 54 sides of electrode body 11A, so that electrolyte solution 12 is more likely to remain.

As a result, the amount of electrolyte solution 12 inside electrode body 11A is smaller in the central portion than on the end faces 53 and 54 sides. Electrolyte solution 12 contains lithium salt and the like. Thus, the salt concentration in electrode body 11A is lower in the central portion than on the end faces 53 and 54 sides.

In this way, when a portion with low salt concentration occurs inside electrode body 11A, the electric resistance in electrode body 11A rises, with the result that the internal resistance in power storage cell 2A rises.

On the other hand, in power storage cell 2 according to the present first embodiment shown in FIG. 3 and the like, electrolyte solution 12 is suppressed from leaking from the inside of electrode body 11 to the outside thereof even when the temperature of electrode body 11 rises. This can consequently suppress that the amount of the electrolyte solution becomes uneven inside electrode body 11, thereby producing a portion with low salt concentration inside electrode body 11.

As a result, despite execution of charging and discharging at a high rate, the internal resistance can be lower than that in power storage cell 2A in a comparative example.

FIG. 11 is a cross-sectional side view showing power storage cell 2A in the event of charging and discharging at a high rate. The portion of electrode body 11A that is located on the curved portion 55 side means a portion located above connection portion 60. Also, the portion of electrode body 11A that is located on the curved portion 56 side means a portion located below connection portion 61.

Upon execution of charging and discharging at a high rate in power storage cell 2A, the temperature in electrode body 11A is higher on the central portion side than on the curved portions 55 and 56 sides.

Thus, the amount of bulging deformation of electrode body 11A is larger in the central portion than on the curved portions 55 and 56 sides.

Accordingly, a gap is more likely to occur between the sheets such as positive electrode sheets in connection portions 60 and 61 and their surrounding areas in electrode body 11A.

When a gap occurs inside electrode body 11A in this way, the electric resistance in electrode body 11A rises and the internal resistance in power storage cell 2A rises.

On the other hand, in power storage cell 2 according to the present first embodiment, pressing members 13 and 14 press connection portions 60 and 61 of electrode body 11 as shown in FIG. 6, thereby suppressing occurrence of a gap therein.

Thus, the internal resistance in power storage cell 2 is suppressed from rising despite execution of charging and discharging at a high rate.

In this way, according to power storage cell 2 in the present first embodiment, despite execution of charging and discharging at a high rate, the salt concentration can be suppressed from becoming uneven inside electrode body 11, gaps can be suppressed from occurring on the curved portions 55 and 56 sides of electrode body 11, and the internal resistance in power storage cell 2 can be suppressed from rising.

In the present first embodiment, a lithium ion battery has been mainly described, but the present disclosure is applicable also to a nickel-metal hydride battery.

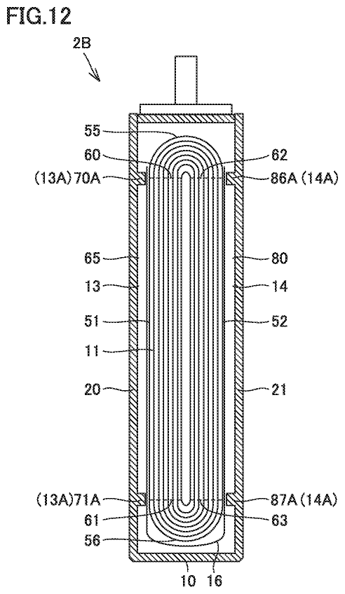

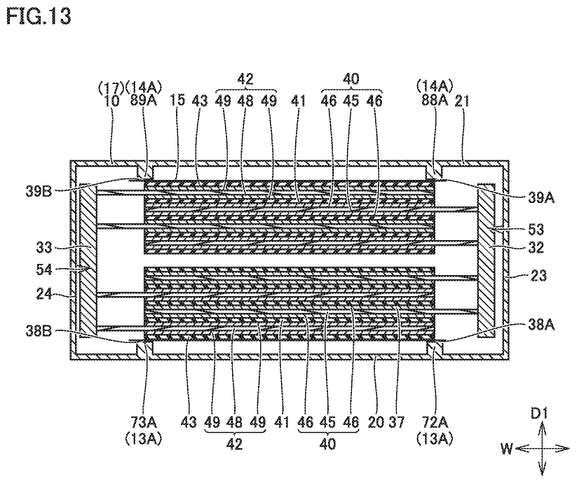

FIG. 12 is a cross-sectional side view showing a power storage cell 2B that is a modification of power storage cell 2. FIG. 13 is a cross-sectional plan view showing power storage cell 2B.

Power storage cell 2B includes a housing case 10, an electrode body 11, an electrolyte solution 12, a pressing member 13A, a pressing member 14A, and insulating paper 16.

Insulating paper 16 is formed so as to cover electrode body 11 from below and located between the inner surface of case body 17 and electrode body 11.

Pressing member 13A is formed on the inner surface of main plate 20 of housing case 10 so as to protrude from the inner surface of main plate 20.

Pressing member 13A connected in a cyclic shape includes pressing edges 70A, 71A, 72A, and 73A.

Pressing edges 70A and 71A press connection portions 60 and 61, respectively, of electrode body 11 with insulating paper 16 interposed therebetween. Pressing edges 72A and 73A press edge portions 38A and 38B, respectively, of electrode body 11 with insulating paper 16 interposed therebetween.

Pressing member 14A is formed on the inner surface of main plate 21 of housing case 10 so as to protrude from the inner surface of main plate 21. Pressing member 14A includes pressing edges 86A, 87A, 88A, and 89A connected in a cyclic shape. Pressing edges 86A and 87A press connection portions 62 and 63, respectively, of electrode body 11 with insulating paper 16 interposed therebetween. Pressing edges 88A and 89A press edge portions 39A and 39B, respectively.

In this way, also in the present modification, edge portions 38A and 39A of electrode body 11 are pressed by pressing edges 72A and 88A, respectively. Furthermore, edge portions 38B and 39B of electrode body 11 are pressed by pressing edges 73A and 89A, respectively.

Thus, electrolyte solution 12 can be suppressed from leaking from the inside of electrode body 11 to the outside thereof despite execution of charging and discharging at a high rate. This can suppress formation of a portion with low salt concentration inside electrode body 11, and also can suppress a rise in internal resistance in power storage cell 2B.

Also in power storage cell 2B, connection portions 60 and 61 of electrode body 11 are pressed by pressing edges 70A, 86A, 71A, and 87A. Thus, gaps can be suppressed from occurring in portions of electrode body 11 that are located on the curved portions 55 and 56 sides when charging and discharging at a high rate is desired.

Thus, also in power storage cell 2B, the internal resistance in power storage cell 2B can be suppressed from rising despite execution of charging and discharging at a high rate.

### Second Embodiment

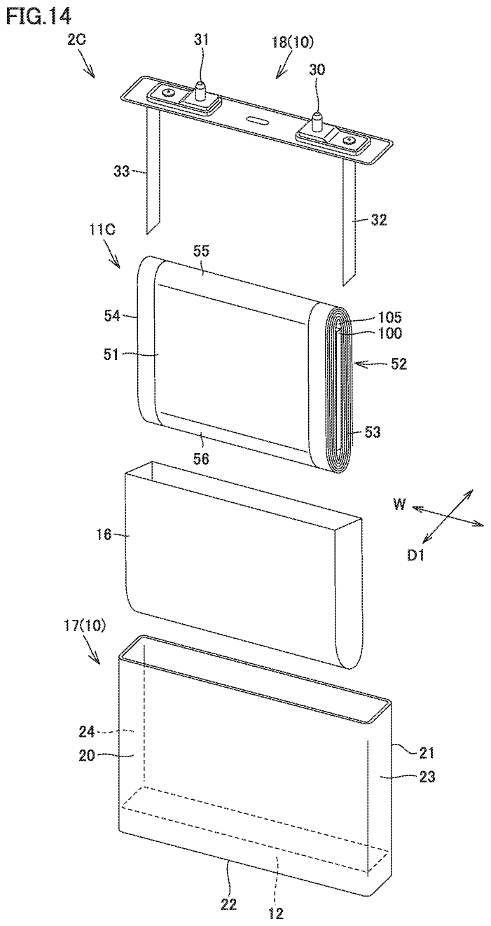

In the following, a power storage device according to the present second embodiment will be described with reference to FIG. 14 and the like. The power storage device according to the present second embodiment also includes a plurality of power storage cells 2C as in power storage device 1 according to the first embodiment described above. FIG. 14 is an exploded perspective view showing a power storage cell 2C according to present second embodiment.

Power storage cell 2C includes a housing case 10, an electrode body 11C, an electrolyte solution 12, a pressing member 100, and insulating paper 16.

Electrode body 11C has a hollow portion 105 provided therein. Pressing member 100 is disposed inside hollow portion 105.

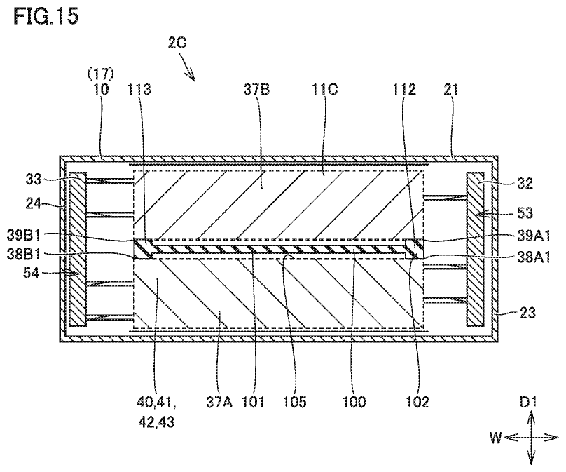

FIG. 15 is a cross-sectional plan view showing power storage cell 2C. Electrode body 11C includes an overlapping portion 37A and an overlapping portion 37B, each of which is formed by overlapping of: a positive electrode composite layer 46; a separator 41; a negative electrode composite layer 49; and a separator 43. Overlapping portion 37A and overlapping portion 37B are adjacent to each other with pressing member 100 interposed therebetween.

On the inner surface of electrode body 11C, overlapping portion 37A includes an edge portion 38A1 located on the end face 53 side and an edge portion 38B1 located on the end face 54 side. On the inner surface of electrode body 11C, overlapping portion 37B includes an edge portion 39A1 located on the end face 53 side and an edge portion 39B1 located on the end face 54 side.

Pressing member 100 is formed of an insulating material such as a resin. Also, positive electrode sheet 40, separator 41, negative electrode sheet 42, and separator 43 are wound around the outer circumferential surface of pressing member 100. Also in the present second embodiment, positive electrode sheet 40, separator 41, negative electrode sheet 42, and separator 43 are formed so as to surround the winding-axis line. Since pressing member 100 and electrode body 11C are integrally formed in this way, electrode body 11C and pressing member 100 can be readily inserted into housing case 10.

Pressing member 100 includes a plate portion 101 and a pressing portion 102. Plate portion 101 is formed in a rectangular plate shape. Pressing portion 102 is formed in a cyclic shape along the outer circumferential edge portion of plate portion 101. Pressing portion 102 is formed so as to bulge from the outer circumferential edge portion of plate portion 101 in arrangement direction D1.

Pressing portion 102 includes a pressing edge 112 and a pressing edge 113. Pressing edge 112 is in contact with edge portions 38A1 and 39A1. Pressing edge 113 is in contact with edge portions 38B1 and 39B1.

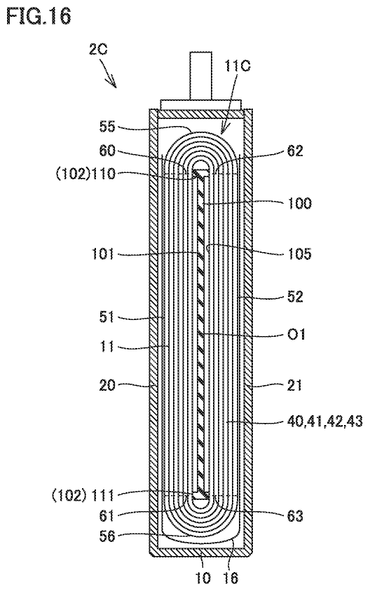

FIG. 16 is a cross-sectional side view showing power storage cell 2C. Pressing portion 102 includes a pressing edge 110 and a pressing edge 111. Pressing edges 110 and 111 and pressing edges 112 and 113 (shown in FIG. 15) are connected in a cyclic shape. Inside electrode body 11C, pressing edge 110 is in contact with connection portions 60 and 62 while pressing edge 111 is in contact with connection portions 61 and 63.

Upon execution of charging and discharging at a high rate in power storage cell 2C configured as described above, electrode body 11C is thermally expanded.

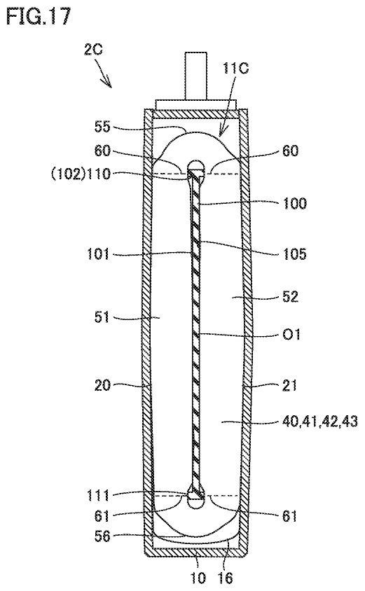

FIG. 17 is cross-sectional side view showing the state where electrode body 11C is thermally expanded due to execution of charging and discharging at a high rate.

Upon execution of charging and discharging at a high rate, the central portion of electrode body 11C is deformed to greatly bulge. Then, electrode body 11C presses main plates 20 and 21 of housing case 10.

Accordingly, electrode body 11C is deformed such that hollow portion 105 provided inside electrode body 11C is reduced in size.

Then, the surface pressure occurring between the inner surface of electrode body 11C and each of pressing edges 110 and 111 of pressing member 100 rises. In other words, the pressing force applied from each of pressing edges 110 and 111 of pressing member 100 to electrode body 11C increases.

The pressing force applied from pressing edges 110 and 111 to connection portions 60 and 61, respectively, of electrode body 11C increases. Thereby, occurrence of gaps in connection portions 60 and 61 of electrode body 11C can be suppressed.

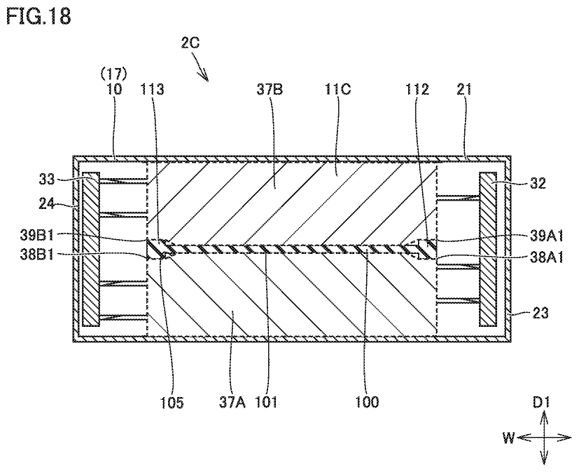

FIG. 18 is a cross-sectional plan view showing the state where electrode body 11C is thermally expanded due to execution of charging and discharging at a high rate.

Also in pressing edge 112 and pressing edge 113 of pressing member 100, the pressing force applied from pressing edge 112 to edge portions 38A1 and 39A1 of electrode body 11C increases while the pressing force applied from pressing edge 113 to edge portions 38B1 and 39B1 of electrode body 11C increases.

Thereby, electrolyte solution 12 inside electrode body 11C can be suppressed from leaking from end faces 53 and 54 to the outside of electrode body 11C.

### Third Embodiment

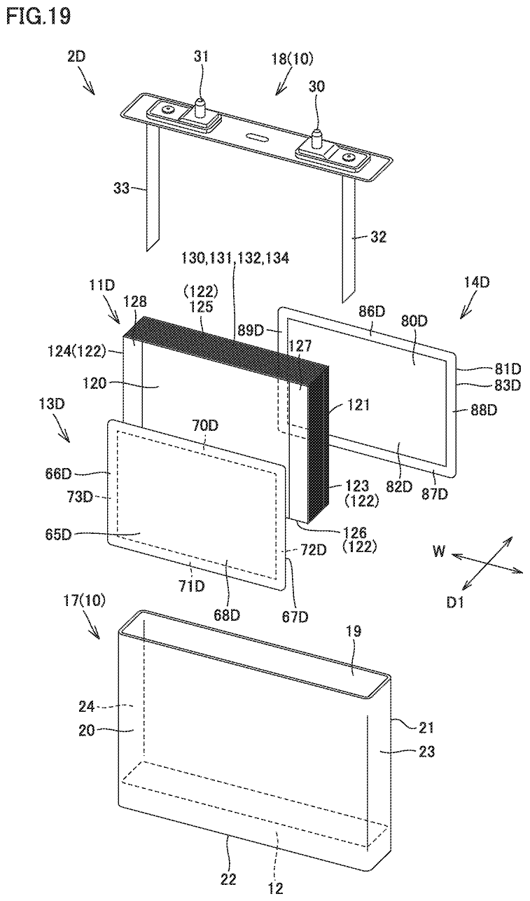

In the following, a power storage cell 2D according to the third embodiment will be described with reference to FIG. 19 and the like. While the example employing a wound-type electrode body has been described in the above first and second embodiments, an example employing a stack-type electrode body will be described in the present third embodiment.

FIG. 19 is an exploded perspective view showing power storage cell 2D. Power storage cell 2D includes an electrode body 11D, a pressing member 13D and a pressing member 14D.

Pressing members 13D and 14D are formed in the same manner as with pressing members 13 and 14, respectively, in the above-described first embodiment. Pressing members 13D and 14D each are formed of an insulating material, thereby ensuring the insulation between electrode body 11D and housing case 10.

Pressing member 13D includes a plate portion 65D and a pressing portion 66D. Plate portion 65D is formed in a rectangular plate shape. Plate portion 65D includes a main surface 67D located to face electrode body 11D, and a main surface 68D located on the opposite side of main surface 67D. Pressing portion 66D is formed on main surface 67D so as to protrude from main surface 67D. Pressing portion 66D is formed in a cyclic shape and includes pressing edges 70D, 71D, 72D, and 73D.

Pressing member 14D includes a plate portion 80D and a pressing portion 81D. Plate portion 80D includes a main surface 82D located to face electrode body 11D, and a main surface 83D located on the opposite side of main surface 82D.

Pressing portion 81D is formed on main surface 82D so as to protrude from main surface 82D toward electrode body 11D. Pressing portion 81D is formed in a cyclic shape and includes pressing edges 86D, 87D, 88D, and 89D.

Electrode body 11D includes a plurality of separators 130, a plurality of positive electrode sheets 131, a plurality of separators 132, and a plurality of negative electrode sheets 133. Electrode body 11D is formed in a flat rectangular parallelepiped shape.

Electrode body 11D includes main surfaces 120, 121 and a circumferential surface 122. Main surfaces 120 and 121 are arranged in arrangement direction D1.

Circumferential surface 122 includes end faces 123 and 124, an upper surface 125, and a lower surface 126. End faces 123 and 124 are arranged in width direction W.

A positive electrode 127 is formed on the end face 123 side of electrode body 11D. A negative electrode 128 is formed on the end face 124 side of electrode body 11D.

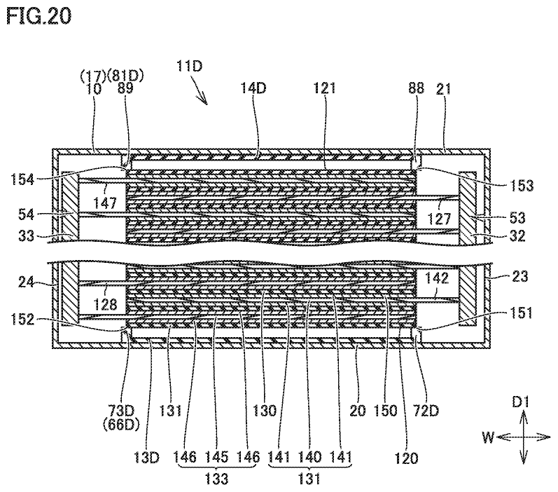

FIG. 20 is a cross-sectional plan view showing power storage cell 2D. As shown in this FIG. 20, electrode body 11D is formed by sequentially stacking a separator 130, a positive electrode sheet 131, a separator 132, and a negative electrode sheet 133.

Positive electrode sheet 131 includes a metal foil 140 and a positive electrode composite layer 141 that is formed on each of the front and back surfaces of metal foil 140. Metal foil 140 includes an unapplied portion 142 on which positive electrode composite layer 141 is not formed. Unapplied portions 142 are arranged in arrangement direction D1, thereby forming a positive electrode 127.

Negative electrode sheet 133 includes a metal foil 145 and a negative electrode composite layer 146 that is formed on each of the front and back surfaces of metal foil 145. Metal foil 145 includes an unapplied portion 147 on which negative electrode composite layer 146 is not formed. Unapplied portions 147 are arranged in arrangement direction D1, thereby forming a negative electrode 128.

In this case, there is an overlapping portion 150 where separator 130, positive electrode composite layer 141, metal foil 140, positive electrode composite layer 141, positive electrode sheet 131, negative electrode composite layer 146, metal foil 145, and negative electrode composite layer 146 overlap with one another.

Unapplied portion 142 protrudes from overlapping portion 150 toward end face plate 23. Unapplied portion 147 protrudes from overlapping portion 150 toward end face plate 24.

On the main surface 120 side of electrode body 11D, the outer circumferential edge portion of overlapping portion 150 includes an edge portion 151 and an edge portion 152. Edge portion 151 is located on the end face plate 23 side while edge portion 152 is located on the end face plate 24 side. On the main surface 121 side of electrode body 11D, the outer circumferential edge portion of overlapping portion 150 includes an edge portion 153 and an edge portion 154. Edge portion 153 is located on the end face plate 23 side while edge portion 154 is located on the end face plate 24 side.

Pressing edge 72D of pressing member 13D presses edge portion 151 of overlapping portion 150. Pressing edge 73D presses edge portion 152 of overlapping portion 150. Pressing edges 72D and 73D extend along edge portions 151 and 152, respectively.

Pressing edge 88 of pressing member 14D presses edge portion 153. Pressing edge 89 presses edge portion 154. Pressing edges 88 and 89 extend along edge portions 153 and 154, respectively.

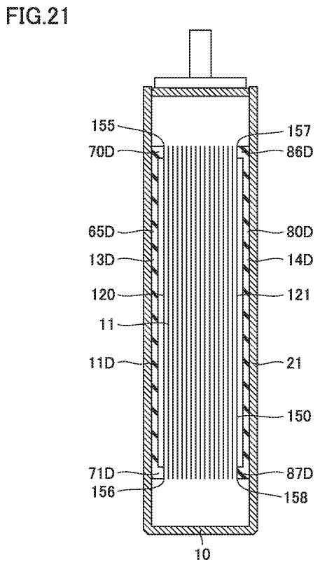

FIG. 21 is a cross-sectional side view showing power storage cell 2D.

On the main surface 120 side, the outer circumferential edge portion of overlapping portion 150 includes edge portions 155 and 156. On the main surface 121 side, the outer circumferential edge portion of overlapping portion 150 includes edge portions 157 and 158.

Pressing edge 70D of pressing member 13D presses edge portion 155 and extends along edge portion 155. Pressing edge 71D presses edge portion 156 and extends along edge portion 156.

Pressing edge 86D of pressing member 14D presses the portion located adjacent to edge portion 157. Pressing edge 86D extends along edge portion 157. Pressing edge 87D presses the portion located adjacent to edge portion 158. Pressing edge 87D extends along edge portion 158.

As shown in FIGS. 20 and 21, on the main surface 120 side, pressing portion 66D of pressing member 13D presses electrode body 11D along the outer circumferential edge portion of overlapping portion 150. On the main surface 121 side, pressing portion 81D of pressing member 14D presses electrode body 11D along the outer circumferential edge portion of overlapping portion 150.

Accordingly, the pressing force from pressing members 13D and 14D is applied in arrangement direction D1 onto circumferential surface 122 or its surrounding area of overlapping portion 150. Consequently, the surface pressure between the sheets is high in circumferential surface 122 and its surrounding area.

Upon execution of charging and discharging at a high rate in power storage cell 2D configured as described above, the central portion of electrode body 11D is thermally expanded. Thereby, the surface pressure between the sheets increases in the central portion of electrode body 11D. Thus, electrolyte solution 12 with which the central portion of electrode body 11D is impregnated tends to move to circumferential surface 122 of electrode body 11.

On the other hand, the surface pressure between the sheets is high in circumferential surface 122 and its surrounding area of electrode body 11D. Thus, leakage of electrolyte solution 12 to the outside of electrode body 11D is suppressed.

Consequently, also in the present embodiment, a portion with low salt concentration can be suppressed from occurring inside electrode body 11D despite execution of charging and discharging at a high rate. Thereby, the internal resistance in power storage cell 2D can be suppressed from rising.

### Fourth Embodiment

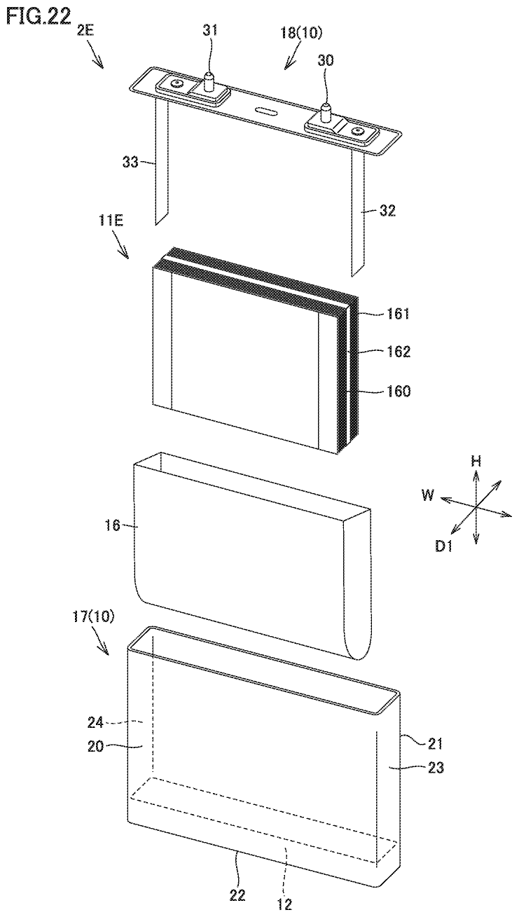

A power storage cell 2E according to the present fourth embodiment will be described with reference to FIG. 22. FIG. 22 is an exploded perspective view showing power storage cell 2E according to the present fourth embodiment.

Power storage cell 2E includes an electrode body 11E and a pressing member 162 that is disposed inside electrode body 11E.

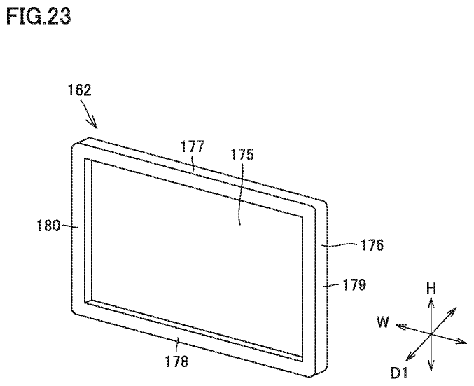

Power storage cell 2E is a stack-type electrode body and includes divided electrode bodies 160 and 161. Divided electrode bodies 160 and 161 are disposed at a distance from each other in arrangement direction D1. FIG. 23 is a perspective view showing pressing member 162. Pressing member 162 includes a plate portion 175 formed in a rectangular shape, and a pressing portion 176 formed in the outer circumferential edge portion of plate portion 175.

Pressing portion 176 is formed along the outer circumferential edge portion of plate portion 175 so as to protrude from plate portion 175 in arrangement direction D1.

Pressing portion 176 is formed in a cyclic shape. Pressing portion 176 includes a pressing edge 177, a pressing edge 178, a pressing edge 179, and a pressing edge 180.

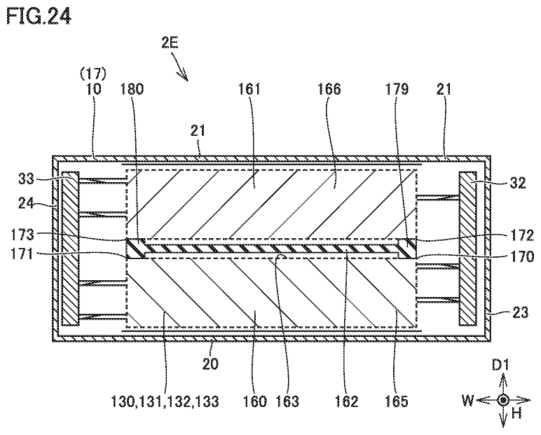

FIG. 24 is a cross-sectional view showing power storage cell 2E. A gap 163 is provided between divided electrode body 160 and divided electrode body 161. Pressing member 162 is disposed inside gap 163. Divided electrode bodies 160, 161 and pressing member 162 can be integrally inserted into housing case 10. Accordingly, divided electrode bodies 160, 161 and pressing member 162 can be readily inserted into housing case 10.

Each of divided electrode body 160 and divided electrode body 161 is formed by sequentially stacking separator 130, positive electrode sheet 131, separator 132, and negative electrode sheet 133.

Divided electrode body 160 includes an overlapping portion 165. Divided electrode body 161 includes an overlapping portion 166.

Overlapping portions 165 and 166 each are formed in such a manner that separator 130, a positive electrode composite layer of positive electrode sheet 131, a separator 132, and a negative electrode composite layer of negative electrode sheet 133 overlap with one another.

On the gap 163 side, the outer circumferential edge portion of divided electrode body 160 includes an edge portion 170 and an edge portion 171, which are formed to extend in a height direction H.

On the gap 163 side, the outer circumferential edge portion of divided electrode body 161 includes an edge portion 172 and an edge portion 173, which are formed to extend in height direction H.

Pressing edge 179 of pressing member 162 is in contact with edge portion 170 of divided electrode body 160 and also in contact with edge portion 172 of divided electrode body 161. Pressing edge 180 of pressing member 162 is in contact with edge portion 171 of divided electrode body 160 and also in contact with edge portion 173 of divided electrode body 161. Pressing edge 179 is formed so as to extend along edge portions 170 and 172. Pressing edge 180 is formed so as to extend along edge portions 171 and 173.

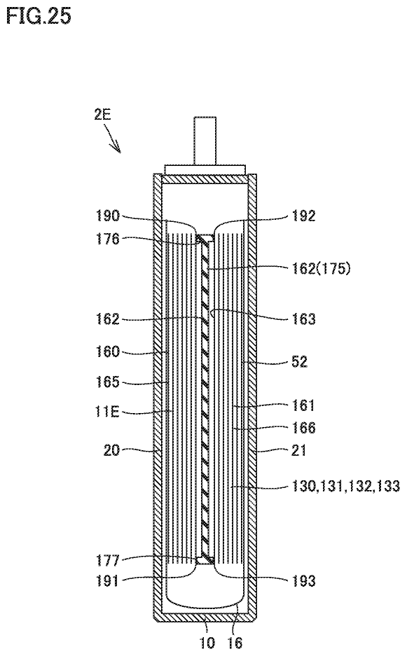

FIG. 25 is a cross-sectional side view showing power storage cell 2E. Divided electrode body 160 includes an edge portion 190 and an edge portion 191 on the gap 163 side.

Pressing portion 176 of pressing member 162 is in contact with edge portions 190 and 192. Pressing portion 176 is formed so as to extend along edge portions 190 and 192. Pressing edge 177 is in contact with edge portions 191 and 193. Pressing edge 177 is formed so as to extend along edge portions 191 and 193.

When charging and discharging at a high rate is executed in power storage cell 2E configured as described above, electrode body 11E is thermally expanded so as to bulge.

In this case, in FIGS. 24 and 25, divided electrode body 160 comes into contact with main plate 20 while divided electrode body 161 comes into contact with main plate 21. Furthermore, gap 163 is also reduced in size.

In this case, in FIG. 24, divided electrode body 160 comes into contact with main plate 20, and also, the surface pressure between divided electrode body 160 and each of pressing edges 179 and 180 rises.

As a result, on the end face plate 24 side, overlapping portion 165 of divided electrode body 160 is sandwiched between main plate 20 and pressing edge 180. Similarly, on the end face plate 23 side, overlapping portion 165 is sandwiched between main plate 20 and pressing edge 179.

Furthermore, divided electrode body 161 comes into contact with main plate 21 while the surface pressure between divided electrode body 161 and each of pressing edges 179 and 180 rises. As a result, on the end face plate 24 side, overlapping portion 166 of divided electrode body 161 is sandwiched between main plate 21 and pressing edge 180. Similarly, on the end face plate 23 side, overlapping portion 166 is sandwiched between main plate 21 and pressing edge 179.

Also in FIG. 25, similarly, edge portion 190 of overlapping portion 165 is sandwiched between main plate 20 and pressing edge 176 while edge portion 191 of overlapping portion 165 is sandwiched between main plate 20 and pressing edge 177. Edge portion 192 of overlapping portion 166 is sandwiched between main plate 21 and pressing portion 176 while edge portion 193 of overlapping portion 166 is sandwiched between main plate 21 and pressing portion 177.

As a result, the surface pressure between the sheets rises on each of the circumferential surfaces of divided electrode bodies 160 and 161, so that electrolyte solution 12 with which electrode body 11E is impregnated can be suppressed from leaking to the outside of electrode body 11E.

In this way, also in power storage cell 2E according to the present embodiment, the internal resistance in power storage cell 2E can be suppressed from rising despite execution of charging and discharging at a high rate.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
an electrode body including a positive electrode sheet, a separator, and a negative electrode sheet;
a housing case in which the electrode body is housed;
an electrolyte solution housed in the housing case; and
a pressing member provided inside the housing case and configured to press the electrode body, wherein
the electrode body having the positive electrode sheet, the separator and the negative electrode sheet stacked on one another is wound around a winding-axis line,
the positive electrode sheet includes a positive electrode metal foil and a positive electrode composite layer that is formed on the positive electrode metal foil,
the negative electrode sheet includes a negative electrode metal foil and a negative electrode composite layer that is formed on the negative electrode metal foil,
the electrode body includes an overlapping portion formed of the positive electrode composite layer, the separator and the negative electrode composite layer,
the electrode body includes
a first flat portion and a second flat portion that are arranged in a thickness direction of the electrode body, each of the first flat portion and the second flat portion being formed in a flat plane shape,
a first winding end face and a second winding end face that are arranged in an extending direction of the winding-axis line, each of the first winding end face and the second winding end face being formed by winding an end edge of the positive electrode sheet, an end edge of the separator and an end edge of the negative electrode sheet,
a first curved portion located on a side of one end of the electrode body in a direction that intersects with the extending direction of the winding-axis line and that intersects with the thickness direction, the first curved portion being configured to connect the first flat portion and the second flat portion, and
a second curved portion located on a side of the other end of the electrode body, the second curved portion being configured to connect the first flat portion and the second flat portion, and
the pressing member includes
a first pressing portion configured to press a portion that is included in an outer circumferential edge portion of the overlapping portion and that is adjacent to the first winding end face, and
a second pressing portion configured to press a connection portion between the first flat portion and the first curved portion.

2. The power storage device according to claim 1, wherein
the pressing member is formed of an insulating material, and disposed on an outer circumferential surface of the electrode body.

3. The power storage device according to claim 1, wherein
the electrode body has a hollow portion provided therein, and
the pressing member is formed of an insulating material and disposed in the hollow portion.

4. A power storage device comprising:
an electrode body formed by stacking a positive electrode sheet, a separator, and a negative electrode sheet in a stacking direction;
a housing case in which the electrode body is housed;
an electrolyte solution housed in the housing case; and
a pressing member provided inside the housing case, wherein
the electrode body includes the positive electrode sheet, the separator, and the negative electrode sheet that are stacked in the stacking direction,
the positive electrode sheet includes a positive electrode metal foil and a positive electrode composite layer that is formed on the positive electrode metal foil,
the negative electrode sheet includes a negative electrode metal foil and a negative electrode composite layer that is formed on the negative electrode metal foil,
the electrode body includes a stack portion formed by stacking the positive electrode composite layer, the separator, and the negative electrode composite layer,
the electrode body includes
a first main surface located at one end of the electrode body in the stacking direction, and
a second main surface located at the other end of the electrode body in the stacking direction, and
the pressing member is configured to press the electrode body along an outer circumferential edge portion of a region that is included in the first main surface and that is located at a position of the stack portion.

5. The power storage device according to claim 4, wherein
the pressing member is formed of an insulating material, and disposed on an outer circumferential surface of the electrode body.

6. The power storage device according to claim 4, wherein
the pressing member is formed of an insulating material, and disposed inside the electrode body.
